(19) United States
(12) Patent Application Publication
(10) Pub. No.: US 2005/0044575 A1
(43) Pub. Date: Feb. 24, 2005

(54) Real-time broadcast of interactive simulations

(76) Inventor: Chris Van Der Kuyl, Dundee (GB)

Correspondence Address: RATNERPRESTIA, P O BOX 980, VALLEY FORGE, PA, 19482-0980, US

(21) Appl. No.: 10/485,714

(22) PCT Filed: Aug. 2, 2002
(86) PCT No.: PCT/GB02/03574

(30) Foreign Application Priority Data
Aug. 2, 2001 (GB) 0118872.1

(51) Int. Cl. H04N 7/173

(52) U.S. Cl. 725/100

(57) ABSTRACT

An entertainment server (100) carries out a simulation, such as a horse training and racing game. Users can interact with the server, however, and a simulation module (400) prepares individual events such as races which are rendered in high quality video by a rendering engine (200) and transmitted during the simulation through a distribution network (250) to users' homes. Preferably, a betting game enables users to wager on the outcome of these races.

### FIELD OF THE INVENTION

The invention relates to a method of providing interactive entertainment and apparatus therefore, and more particularly to a method of providing multi-player interactive entertainment over television or other distribution networks, and a computer apparatus for facilitating a multi-player interactive entertainment through television or other distribution networks. The interactive entertainment can also be used to generate revenue from associated betting.

### BACKGROUND TO THE INVENTION

A popular type of multi-player computer game is a simulation. In a simulation, some aspects of an artificial world develop through time, responding to instructions made by players. Simulations are known which emulate sport competitions; for example, computer games which enable participants to acts as managers of a football team or horse trainers where their actions influence the result of football matches or horse races.

The use of motion tracking, using for example magnetic sensors attached to an actor, to provide an input to a computer simulation for real-time animated television broadcast is known. For example such virtual actor technology is provided by SimGraphics of South Pasadena, Calif., USA. However the approach is not suitable for interactive entertainment where instructions from viewers (as opposed to measurements from actor) affect the outcome of a simulation.

The invention described in the present Application relates particularly to a horse racing simulation where players train horses and enter their horses into races. However, it will be immediately clear to one skilled in the art that it can be applied to all manner of simulations, for example different sports or other types of simulations.

One reason that multi-player computer games have not achieved mass popularity is due to the difficulty of providing an accessible interesting game in a form which is easy to use by the general public. Interactive television is an easy to use medium with which the general population is becoming more familiar.

It would be highly desirable to provide new forms of entertainment through interactive television. However the ability to do this for a multi-player game is limited by the difficulty of transmitting different information to different players. Generally only low speed data links are available in a television distribution system for communicating with individual users of the system. Such links are suitable for providing web pages or menus but are not suitable for transmitting personalised state of the art animated computer graphics.

It is an object of the present invention to provide real-time broadcast of interactive simulations.

A further object of the present invention is the generation of revenue. The revenue may be generated through advertising, user participation and through gambling by providing an interesting new format and new competitions which are interesting subjects for gambling.

### BRIEF DESCRIPTION OF THE INVENTION

According to a first aspect of the present invention
there is provided an entertainment system comprising:
a simulation module, adapted to run a simulation comprising calculative iterations and an outcome, the outcome being at least partially dependent on instructions received from a plurality of users;
input hardware for receiving instructions from users;
a rendering module for preparing signals corresponding to video images depicting aspects of the calculative iterations of the simulation, for feeding prior to said outcome being simulated said signals into a distribution network adapted for distributing said signals to a plurality of users.

Preferably aspects of the simulation depend on random or pseudo-random numbers.

Preferably a terminal is a set-top box.

Preferably the simulation comprises a plurality of simulated entities having properties which affect the outcome of interactions therebetween, and wherein said video images depict interactions between said entities.

Preferably said entities represent horses and the entertainment system further comprises:
a storage module adapted to store information about at least one of said horses;
said information comprising attributes affecting the horse performance in races;
wherein user's instructions affect the development with time of horse's attributes; and, wherein the video images depict races between horses, the outcome of the races being at least partially responsive to the horse attributes.

Optionally the entertainment system further comprises television broadcast apparatus for broadcasting a television signal.

This aspect is particularly suitable for providing, for example, a horse racing game in which individual user's can interact with the simulation module; for example, buying and selling horses, determining how they are trained, hiring trainers and jockeys and entering them into races. These commands to the simulation module require relatively low bandwidth connections specific to each user. However, the rendering module can prepare high quality video images using state of the art graphics generation techniques which are then transmitted to users via conventional television distribution methods. This is a highly economic method of providing interesting entertainment as it does not require a high bandwidth link specific to each user to be provided and the high quality software and hardware rendering engine used to prepare the video images can be maintained in only one place and the resulting images transmitted as conventional television pictures. Importantly, this also provides access to the multi-player game to user's through the convenient, familiar interface of their television.

According to a second aspect of the present invention there is provided an entertainment server executing a simulation comprising calculative iterations and an outcome, and being adapted to receive instructions from a plurality of users; the users instructions affecting the simulation, the game server further being adapted to send to a rendering engine the information required for preparing a video image sequence relating to an aspect of the calculative iterations of the simulation; said video image sequence being for transmission through a distribution network prior to said outcome being simulated.

Preferably the entertainment server is further adapted for storing information about entities, wherein entities have attributes affecting their performance in interactions, wherein users' instructions affect the development with time of entities' attributes and wherein the video images depict interactions between entities, the outcome of the interactions being responsive to the entities' attributes.

Preferably the entertainment server is further adapted for storing information about horses, wherein horses have attributes affecting their performance in races, wherein users' instructions affect the development with time of horses' attributes and wherein the video images depict races between horses, the outcome of the races being responsive to the horses' attributes.

According to a third aspect of the present invention there is provided a method for interactive entertainment comprising the steps of:
receiving instructions from a plurality of users;
running a simulation comprising calculative iterations and an outcome, the development of the simulation at least partially dependent on the instructions received;
preparing signals corresponding to video images depicting aspects of the calculative iterations of the simulation; and
distributing said signals to a plurality of users prior to said outcome being simulated.

Preferably said step of distributing is performed via a television distribution network.

Preferably the development of the simulation further depends at least partially, on randomly or pseudo-randomly generated parameters.

Preferably said instructions are received via user's set-top boxes.

Preferably the simulation comprises simulated creatures having properties which affect the outcome of competitions and the video images depict competitions between creatures.

Preferably the method comprises the step of storing information about entities, wherein entities have attributes affecting their performance in interactions, wherein users' instructions affect the development with time of entities' attributes and wherein the video images depict interactions between entities, the outcome of the interactions being responsive to the entities' attributes.

Preferably the method comprises the step of storing information about horses, wherein horses have attributes affecting their performance in races, wherein users' instructions affect the development with time of horses' attributes and wherein the video images depict races between horses, the outcome of the races being responsive to the horses' attributes.

Optionally the method further comprises the step of preparing the video images for television broadcast.

According to a fourth aspect of the present invention there is provided a method of generating revenue comprising the steps of:
running a computer-based simulation comprising calculative iterations and an outcome, the outcome being at least partially dependent on instructions received from a plurality of users;
inviting players to place bets upon the outcome of depicted aspects of the simulation;
rendering video images depicting aspects of the calculative iterations of the simulation;
transmitting prior to said outcome being simulated said video images into a distribution network; and
paying out real or simulated money dependent on the outcome of depicted aspects of the simulation.

Preferably the simulation simulates entities, wherein entities have attributes affecting their performance in interactions, wherein users' instructions affect the development with time of entities' attributes and wherein the video images depict interactions between entities, the outcome of the interactions being responsive to the entities' attributes.

Preferably the simulation simulates horses, wherein horses have attributes affecting their performance in races, wherein user's instructions affect the development with time of horses' attributes and wherein the video images depict races between horses, the outcome of the races being responsive to the horses' attributes.

Optionally the outcome of the depicted aspects of the simulation is dependent on random or pseudo-random numbers.

This provides a new way of generating betting revenue. It is generally considered uninteresting to bet on the results of a completely computer-generated event. This is because computers are considered to be impersonal. However, the present simulation, whilst computer generated, simulates races which have been influenced by the actions of human beings and therefore it is interesting to bet upon the outcome of these races. Further, the ‘live’ broadcast of races in real time where the outcome has not been yet simulated is more interesting.

Preferably the simulation module is not fully deterministic but runs a simulation using a pseudo-random number generator to provide non-deterministic input, increasing interest in the results still further.

According to a fifth aspect of the present invention there is provided computer software comprising program instructions which, when loaded onto a computer, cause said computer to perform as the entertainment server according to the second aspect.

According to a sixth aspect of the present invention there is provided computer software comprising program instruction which, when loaded onto a computer, cause said computer to carry out the method according to the third aspect.

According to a seventh aspect of the present invention there is provided computer software comprising program instruction which, when loaded onto a computer, cause said computer to carry out the method according to the fourth aspect.

### DESCRIPTION OF THE DRAWINGS

An example of embodiment of the present invention will now be illustrated with reference to the following drawings in which:

FIG. 1 is a schematic illustration of an entertainment system;

FIG. 2 is a schematic block diagram of a game server;

FIG. 3 is a schematic block diagram of a race generation module and rendering engine;

FIG. 4 illustrates a set-top box used with the entertainment system;

FIG. 5 is a flow chart of a sample procedure used to calculate the outcome of a race;

FIG. 6 illustrates a flow chart of events broadcast sequentially by the television channel scheduler;

FIG. 7 illustrates the timescale of a betting game;

FIG. 8 illustrates the loss of stamina with horse speed relative to cruising speed;

FIG. 9 illustrates a link between remaining stamina and horse top speed;

FIG. 10 illustrates a sample screen summarising a race programme;

FIG. 11 illustrates a sample screen of a bet placing procedure; and

FIG. 12 illustrates a sample screen of a bet confirming procedure.

### DETAILED DESCRIPTION OF AN EXAMPLE EMBODIMENT OF THE INVENTION

This example embodiment provides an entertainment system used to run two games simultaneously and continuously, both relating to horse races. In the first game, known as the owner's game, players own and control various aspects of the training of horses which they can enter into races. The second game, known as the betting game, is linked with this game and enables players to gamble on the outcome of simulated races.

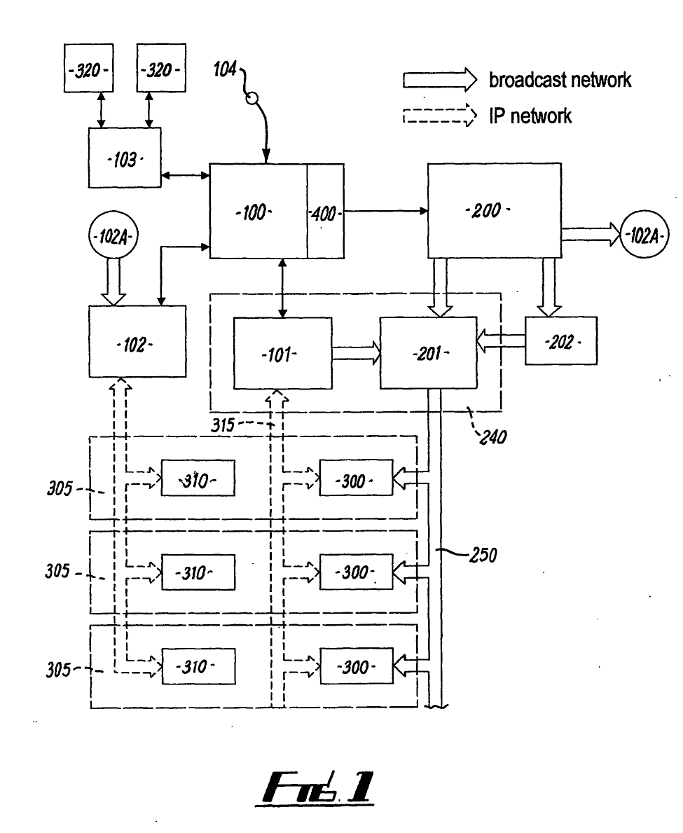

FIG. 1 illustrates a block diagram of the system as a whole. A simulation is carried out continuously over a period of time by a game server 100. Periodically horse races are simulated by a race generating module 400 and a rendering engine 200 provides high quality video images transmitted down a television network 250 to users' television set top boxes 300 for display on their televisions during the simulation. Optionally, simulated game time is faster than real time; for example, one game year may take three months in real time.

The game server has hardware interfaces 101, 102, 103 for communicating with players of the game. The prime communication route is through the interactive television channel head end 240 which provides broadcast data in one direction through broadcast network 250 and two-way communication of out of band data takes place through an IP network 315. Television channel head end 240 comprises a data control and conversion module 101 running Liberate Connect™ Suite from Liberate™ of San Carlos, Calif. and a television broadcast multiplexer 201.

Menus are presented to users and user selections are communicated back to the game server 100. An example menu allows a user to select a race into which a horse can be entered from a series of options. Other ways of making selections and placing bets are discussed below. Players can communicate along any of these different channels, for example they can use their set top boxes 300 which communicate with data control and conversion module 101. Users can also have two way interactions with the game server from a standalone PC 310 connecting over the Internet to an HTTP server 102; yet further, users can use telephones or mobile phones 320, such as PSTN telephones connected using a premium rate number or WAP phones communicating through an interface 103 that is respectively a (staffed or automated) call centre or a WML server. Text messages and e-mail may be sent to users including news, tips and results.

An important feature of the game is that although all the communication between the game server and the users is deterministic, the addition of a stream of pseudo-random numbers 104 produces non-deterministic outputs and makes the results of the game more interesting. These pseudo-random numbers influence race results but can also influence other aspects of the simulation such as race scheduling and newly created horses.

In the preferred embodiment, rendering engine 200 takes the results, such as the horse position at a particular calculative iteration, of individual races prepared by the race generating module 400 and converts these into high quality graphic images. These images are then transferred in an appropriate video format to the television broadcast multiplexer 201. Preferably, a monitoring station 202 enables a commentator to view races live and make their audio comments available along with the video images when these are transmitted down the television network 250.

In an alternative embodiment, encoded video streams from the rendering engine 200 are transmitted 102A to the website server 102 that further transmits the streaming video over the internet for reception by a user with broadband internet access. This web broadcast channel may be provided instead of or in addition to the television broadcast. The video encoding, e.g. using MPEG4, may be performed by the rendering engine, or by a separate hardware module.

In another alternative embodiment, encoded video streams from the rendering engine 200 are transmitted to a server that is part of the interface 103 that further transmits the streaming video over a telephone network for reception by a user with mobile phone 320 access. This broadcast channel may be provided instead of or in addition to the television broadcast. Similarly the video encoding, e.g. using MPEG4, may be performed by the rendering engine, or by a separate hardware module.

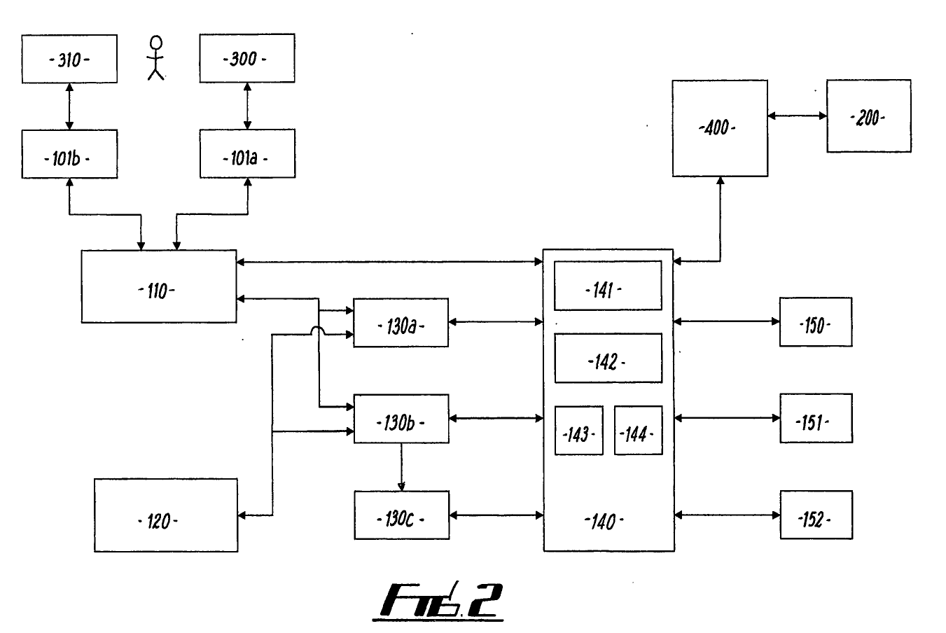

FIG. 2 is a schematic diagram of the game server 100 according to the present invention. The game server 100 comprises a user interface module 110 for interacting with the user. The user can interact using a plurality of different communication devices such as a set top box 300 or personal computer 310. Preferably, the communication is bi-directional; for example, menus are transmitted to a user and the user is invited to select an option; tables, data and fixtures are transmitted to the user. The user can then respond, for example by selecting an option from a menu or in some situations they may supply text, such as the name of a horse. A mailbox stores messages from the game server 100 for display to the user.

User interaction module 110 enables a user to communicate with the game server 100. There is also provided a further software module 120 which enables a game server 100 controlling the system to provide simulated computer players, this module has access to all the same features that players can access directly but is entirely computer controlled. Preferably, at least 20% of the horses in the game will be computer controlled to prevent concerted practices by players fixing results.

In the preferred embodiment, most information in the system is stored in the form of a centrally held database 140. Examples of the type of information held on this database include player information 141 such as: the name of players; their billing information; their address; a simulated cash balance used to buy and sell horses, pay trainers and receive winnings; historical information, such as winnings made in the past in both betting and owner's games; information on horses that they own, for example pointers specifying particular horses the attributes of which are stored in the horse database 142; a list of outstanding races which they have entered which have not yet been simulated and information such as player standing in a league and changes in that position since the previous week.

A horse information database 142 comprises information about individual horses in the race. This may contain for example, the horse name, sex, colour, markings and parameters affecting their performance such as speed, stamina and acceleration. Other information provided may include the rate at which the horse will improve in response to training and the performance limits of the horse. Historical information such as the genealogy of the horse or its previous race results can also be stored in the horse information database 142. The simulation also includes a plurality of horses trainers and information about these trainers is stored in a trainer database 143. This information includes: the name of the trainer, their rating relative to other trainers, the cost of the trainer (annual fees and percentage of winnings), aptitudes, specialities and so forth. A player is required to hire one or more trainers using money from their simulated cash balance before entering horses in races and the trainers attributes will affect improvement of the horses through time. Horses race with jockeys and information about jockeys is stored in a jockey database 144 which again includes information about a jockey's name, their costs in terms of salary and percentage of winnings, and, in an optional embodiment where jockeys affect horse performance, their earnings in the past few months, ratings relative to other jockeys and parameters and attributes which effect the ability they have to alter a horses performance in the race.

Individual software modules 130 can be used to read information from the database 140 and carry out specified procedures in response to instructions received from the user through the user interface 110 and they also provide information back to the user. For example, horse managing module 130a interrogates the horse database 142 and provides a list of horses which are available for purchase and some information about them to players. Importantly, it does not generally provide all of the information that is stored in the database to the players but will provide approximations, for example giving an idea of whether a horse is good or bad or its approximate age although the horse database 142 will store more detailed attributes for the horse. Responsive to instructions received through the user interface module 110, the horse managing module 130a enables the player to buy or sell horses, for example they can purchase a horse whereupon the player database 141 is amended to include a pointer to which the horse is purchased and the horse is deleted from the list of horses on sale in the horse database 142.

The horse managing module 130a enables players to buy and sell horses. They can immediately sell a horse for a calculated value depending on its past performance and genealogy. They can make private sales marking their horse as available for sale to other players, who may indicate an interest in purchasing the horse. Horses can be entered in claiming races which are a specific type of race where third parties may purchase any horse entered.

A trainer managing module 130b enables a player to hire trainers, this module reads the database 143 and provides a summary of trainer's skills, for example a statement that a trainer is excellent or average for long or short distances, rather than providing them with the details of numerical parameters which will be stored in the training database 143. The trainer managing module 130b also implements alterations to horse's attributes with time.

This could also be carried out by a separate software module.

Similarly a jockey management module 130c deals with hiring jockeys for particular races. In this example, jockeys are selected by trainers and so jockey management module 130c is instructed by trainer management module 130b. Software modules 130a-c can also send messages to a player's mailbox. For example, the trainer management module 130b can send a message about how the horse is progressing, and prompts for renewal of contract every 12 months.

The information within the central game database 140 is also altered by a horse generating module 150, a trainer generating module 151 and a jockey generating module 152. The horse generating module creates new horses, usually in the first week of each game year. The horse information described above is put into the database 142 for each new horse. Physical parameters are created for each horse include a speed master rating, stamina master rating and acceleration master rating, speed improvement rate, stamina improvement rate, acceleration improvement rate, maximum soundness level and soundness improvement rate, each ranging from 0 to 100. Preferably, each horse is considered to be the offspring of an existing colt (sire) and existing female (dam), which provides a genealogy for the various horses in the race and information concerning their parents and previous generations are also stored to enable a player to judge the likely ability of a horse.

Preferably, the horse's master rating for speed, stamina and acceleration are created from the master ratings of his sire and dame in such a way to ensure that high quality horses will give rise on average, with random variation, to high quality offspring but that the ratings for each will tend towards the mean. By way of example, each horse in the game has master ratings for speed, stamina and acceleration which are stored in the form of 100 bits either of which is a 1 or a 0 and where the total number of 1's is the value for the master rating, therefore being between 0 and 100. A new horse's master rating for each ability is calculated by combining the bit strings for each of the sire and the dame. Each bit in the sire string is compared sequentially with the corresponding bit in the dam string. When these are both zero the corresponding bit in the new string is zero, when they are both 1 the new bit is 1, however where they are different the new bit is either 0 or 1 as determined with reference to a pseudo random information 104. The horse master ratings determine the maximum which each of speed, stamina and acceleration can reach during the racing career of the horse. In a similar way, parameters are stored to determine the rate at which speed, stamina and acceleration increase. Soundness level, maximum soundness level and soundness improvement rate determine parameters which affect the extent to which racing affect the horses racing performance for a period of each race. A trainer generation module 151 generates new trainers when required and provides them with attributes including those which determine a trainer's ability to affect the improvement of speed, stamina and acceleration of horses with training and whether the trainer is better for long or short distance training. Similarly a jockey generation module 152 generates jockey attributes. In an optional embodiment, jockeys have skill levels which are hidden from the player, these modify each of horses' speed, stamina and acceleration by a relevant small amount.

The game server 100 communicates with a race simulating module 400 which determines individual races. The race simulating module is preferably included as part of the game server 100 as shown in FIG. 1 but could also be integrated with the rendering module 200 or be implemented as one or more standalone systems. The race simulation module 400 requires information concerning the horses participating in a race and information about the trainers and jockeys riding those horses in order to determine the results of the race. It also feeds back information concerning the results to the game server 100, thereby enabling winnings to be credited to a player is simulated cash balance and historical information to be built up in database 140. The rendering module 200 communicates with the race generating module 400. Information from the race generating module 400 is transmitted to the rendering engine 200.

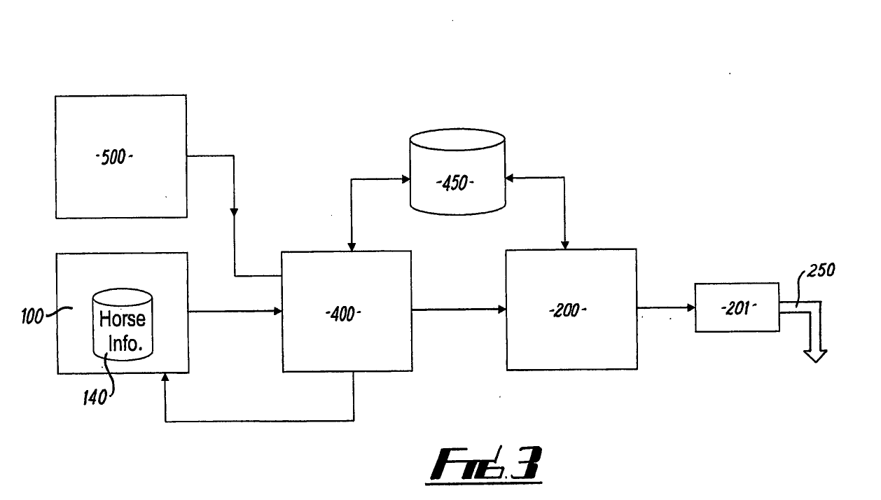

FIGS. 3 illustrates further how the individual races are generated and rendered. A schedule module 500 controls the overall cycle of the game. Typically, races are scheduled every 10 minutes. Races have different parameters associated with them, for example, they take place at one of various different tracks, they will have different conditions, for example, they might be in different parts of the world at different times of the day, they might have individual lighting effects or weather effects.

Races differ in importance, with different prize money and easier or harder entry criteria. Races will take place at specified times set by the scheduling module 500 taking into account other parameters supplied by the scheduling module 500. The race simulator module 400 requests information from the game server 100, horse information 142 and other information specified in the database 140 which is required in order to simulate the race. Additional data can be read in from further sources, such as information on the topography of individual race courses. The race simulator module 400 then simulates a race by a procedure discussed below. The output from the race simulator 400 is series of data points showing the location of horses at different times during the race, in particular it calculates the position of horses at each frame which will be rendered, for example, each 20 milliseconds. The race generating module 400 also calculates further information such as animation cycling information which will be used by the renderer 200. All this information is stored in database 450 which can also be accessed by the rendering engine 200.

The rendering engine 200 reads in the information concerning the race from the database 450 and also any other graphic information required and by well-known techniques renders a graphic image of the race. Preferably the rendering engine 200 comprises a PC having a PC-based 3D accelerator card using the GeForce3® chipset from NVidia® of Santa Clara, Calif., but other sufficiently fast 3D accelerators could readily be used as will be clear to one skilled in the art. Rendering engine 200 preferably uses the DirectX® 8 protocol, available from Microsoft® of Redmond, Wash. Rendering takes place from a series of different simulated viewpoints, some emulating the view from a fixed camera and some simulating moving views from moving trackside cameras or helicopters. Output comprises a series of consecutive views from different cameras.

The camera target is evaluated separately to camera position. A bounding box, being a cuboid of calculate dimensions and position is determined for each frame focusing on a target such as: encompassing first three horses, encompassing entire pack, encompassing last 5 horses, or focussing in on the first horse, last horse or a specified horse. For each frame, given the camera location and the bounding box, a zoom factor is calculated so that each bounding box is scaled appropriately to give a full screen view of desired size. When targets are changed, the zoom factor smoothly transitions from a first zoom factor to a new zoom factor. Pseudo-random camera motion may be included. The display consists of a series of camera shots specifying which camera is used, which mode the camera is in, the target the camera will initially focus on, the target it will finally focus on and, for moving cameras, the path the camera will follow. Camera shots can be decided upon randomly or following a script or algorithm.

The rendering prepares a high quality video image stream, preferably MPEG II encoded video and audio which is then transmitted to the television broadcast multiplexer 201, perhaps involving a change of image format and is then distributed through the television distribution system 250 to individual users home 305.

FIG. 4 is a schematic diagram illustrating a user's interactive television set top box configuration. The set top box 300 receives a signal from the cable television channel 250 and has an additional communication capability 315 such as a cable telephone connection for two-way communication with communications module 101. Game information received from the television network is displayed on the television 330 and this may be combined with information received specifically for a predetermined set top box 350, for example a menu relating to the game from which the user can select one of a number of horses to purchase.

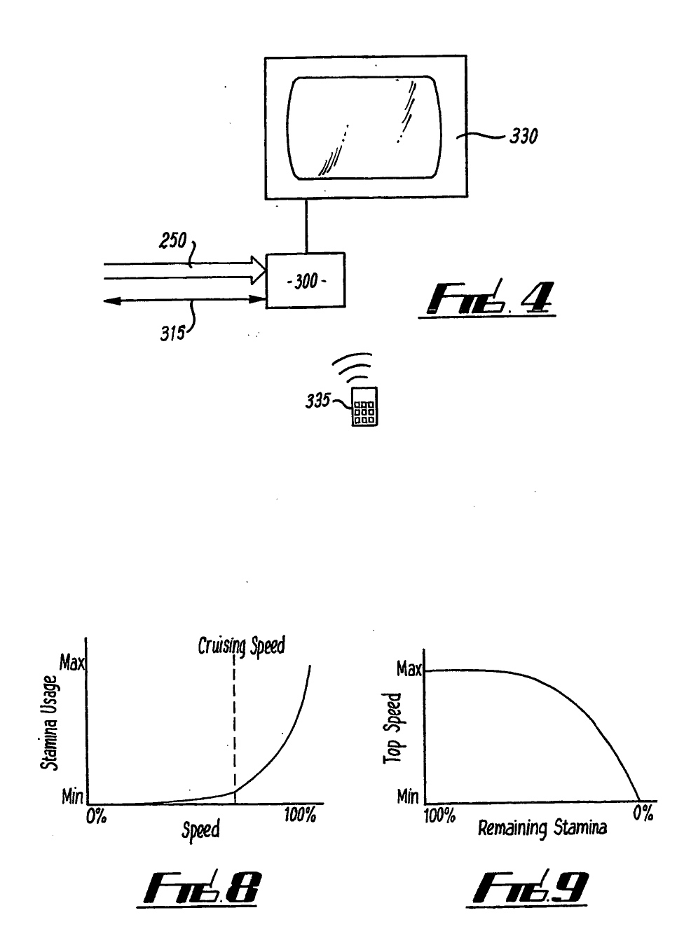

FIG. 5 illustrates an example of the process by which individual races are simulated. A race is initialised 600 following a request from a scheduling module 500. The relevant information is then retrieved 601 including race specific information and horse specific information including jockey and trainer specific information. The position of horses is maintained as x and y co-ordinates on a simulated race track. These co-ordinates are set initially to start positions at a time zero, representing the start time of the race 602.

Next, a procedure calculates new horse positions 603 from those at the previous interval of time using a combination of horse specific parameters and a certain level of random numbers 604 supplied by pseudo random number generator 104. The pseudo random numbers are not typically generated at each time interval, rather they are is incorporated into the calculation of a frame by applying them once at the beginning of the race.

Data is written 605 to the race database 450 for use of the rendering engine 200 that concurrently during the simulation reads 606 the race database and renders 607 corresponding image frames that are broadcast 608 to users by the interactive television channel head end 240. The step of writing the data may include writing the data to an offsite auditor.

The steps 603 to 605 are repeated for each time interval up to and including the outcome of the race then further simulation may continue.

Information about the results of the race is also returned 609 to the game server 100 which allocates prizes to owners and leading horses.

The data stored in the race database may be used for further rendering and broadcast after the race, for example for slow motion action replays. This further rendering can be controlled by user input, for example with users requesting or voting to choose which section of the race to replay.

The simulation requires the following variables from the horse information database 142: the name of the horse, jockey name, maximum speed, maximum acceleration, initial stamina, cruising speed, consistency, tactics, sprint point (from which a horse sprints for the line), preferred surface and preferred going. Different races take place on tracks with different surfaces (dirt, turf) and different going, (firm through soft) and horses perform best on tracks with properties most similar to their preferred type. A track file specifies the location of the inner and outer rails of a track, start and finish lines and racing line preferred by horses. The racing line converges to a single line around corners but can be a broad strip on straights where position is least importance.

The movement of a horse is a combination of separate algorithms. Horse behaviour is implemented as an emergent behaviour, that is to say, a behaviour which emerges from the activation of a relatively small rules set, preferably taking into account current simulated world situation (horse positions, speeds and track shape) only.

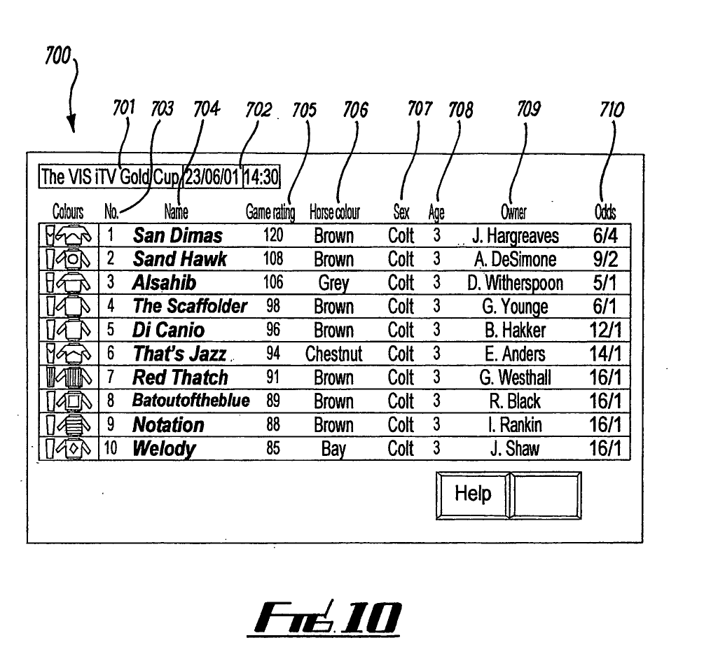

A remaining stamina parameter is set to the value of ‘initial stamina’ and decreases as the race is run depending on the actual speed of the horse and the difference between that speed and their cruising speed. FIG. 8 illustrates the relationship between running speed and stamina usage and FIG. 9 shows how top speed drops as remaining stamina declines. A minimum speed of 60% of initial top speed is set to allow a horse to eventually finish.

A horse tends naturally to revert to its cruising speed unless its tactics dictate otherwise. Cruising speed can vary during a race and the amount to which this varies during the race depends on a horse's consistency parameter.

By way of example, relating to the specific example of horse races, movement takes into account the abilities of each horse, collision avoidance algorithms, aversion algorithms, a flocking algorithm to simulate a natural pattern of horses and a path finding algorithm to establish a way between other horses. Algorithms also implement tactics, such as a tendency to run to the lead from the start, run for position in the middle of the pack and run for the lead near the end or run at the back of the pack making a late run. Horses with poor temperaments will run further from other horses. Front runners aim to accelerate if they drop more than a set distance behind the leader, middle runners make a sprint for the lead a specified distance from the end but will otherwise tend toward their cruising speed provided they are not more than a specified distance behind the first and second place horses. Late runners are content to stay near the back before making a late run and will tend toward their cruising speed when they are within set distances behind the leader and fifth placed horses. Each horse has a preferred sprint point, being a position within a race from which they will accelerate to above their cruising speed.

Preferably, late runners sprint from 75% through the race, middle runners sprint from 85% and leader types will sprint from 90% of elapsed race distance. A randomization of +/−4% in these positions avoids having all horses of a particular type sprint at the same time.

A decision making algorithm takes into account current speed and direction, tactics, tendency to the racing line and cruising speed to prepare a vector representing the horse's desired position and speed at the next time interval calculation. Next, an aversion module is applied. This investigates whether a horse can go to the desired position, taking into account inner and outer rails and the location of other horses. If the desired position is barred by this type of collision checking, an appropriate alteration to the vector is made. Finally, a physical simulation module investigates whether the vector determined by the decision making algorithm and perhaps altered by the aversion module is within the physical capabilities of the horse. This takes into account a horse's current maximum speed, maximum acceleration, maximum turning circle and ensures the desired position does not breach the physical limits set by the simulation. If it does, then the vector is modified to conform to these limits.

After applying these algorithms, the game simulator 400 applies the vector to the horses position at the previous frame, performs a final collision check to ensure no horse is overlapping with another horse or the rail and stores this new position in race database 450. The new position is generally used as the starting point of the next calculative iteration.

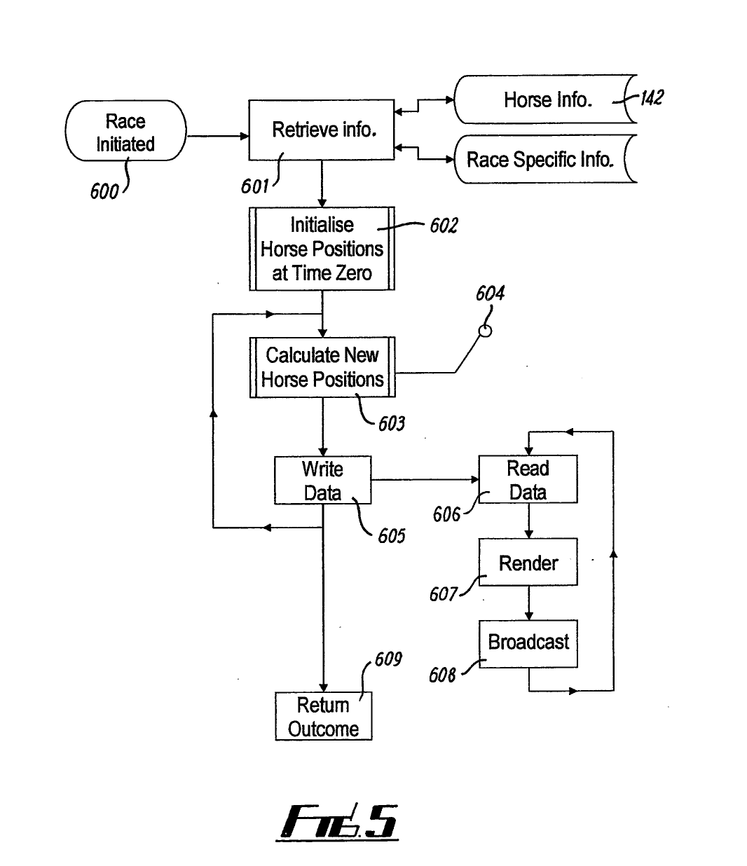

FIG. 6 illustrates an example of the repeating program shown on the cable television channel. The programme lasts about 10 minutes and begins with an introduction to the races and to the channel 620. There then follows brief tutorial 621 as to how the cable channel works and how to interact with it. The results of the previous race are then presented 622 following which, a programme for the next race is presented 623. Rendered images then show the various horses parading before the race 624. Trailers 625 can be included discussing for example, important upcoming races. Analysis of the race 626 is then provided and may include video images of a commentator discussing the race. There is then a commercial break 627 where advertising material is transmitted, followed by the race 628. The race results 629 are then displayed. The program scheduling shown in FIG. 6 can be controlled by the scheduling module 500 or a separate channel scheduling module, including an element of operator control.

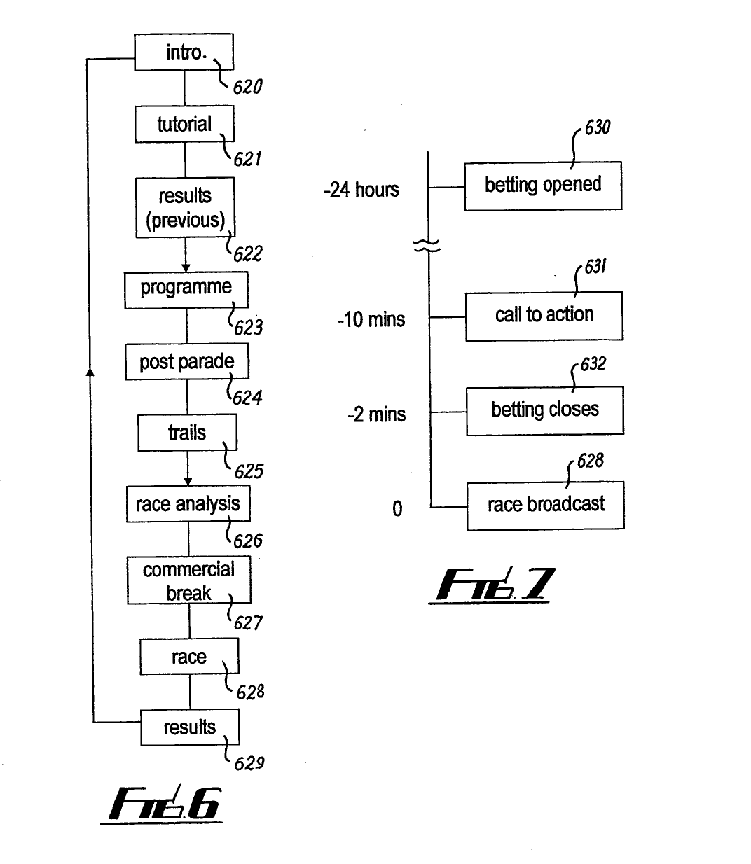

FIG. 7 illustrates a schedule of a betting game linked to the owners game. In the betting game players bet on the outcome of races. Player's may play using virtual money or may stake real money. Bets may be of any type known in conventional horse racing such as “to- win”, “each-way” or more complex formats including bets based on results of multiple races.

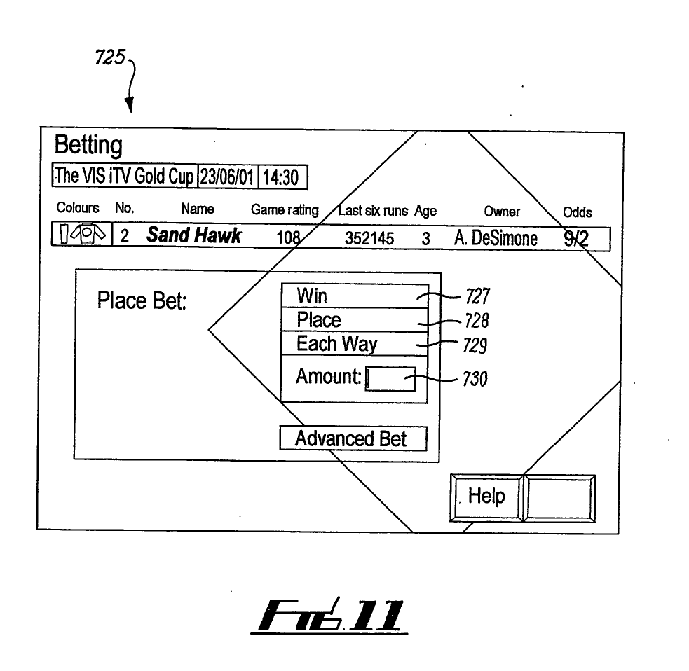

Betting for each race opens 630 a set time before the race; for example, twenty-four hours. After betting is opened, a participant can place a wager at any time. FIG. 10 illustrates a screen image of a listing 700 for a race, showing the name of the race 701, date and time 702 and various parameters for each horse, particularly race number 703, name 704, game rating 705, colour 706, gender 707, age 708, owner name 709 and odds 710. Button icons 711, 712 selectable by pressing a correspondingly coloured remote control button allow a user to access a help function and return to normal television viewing.

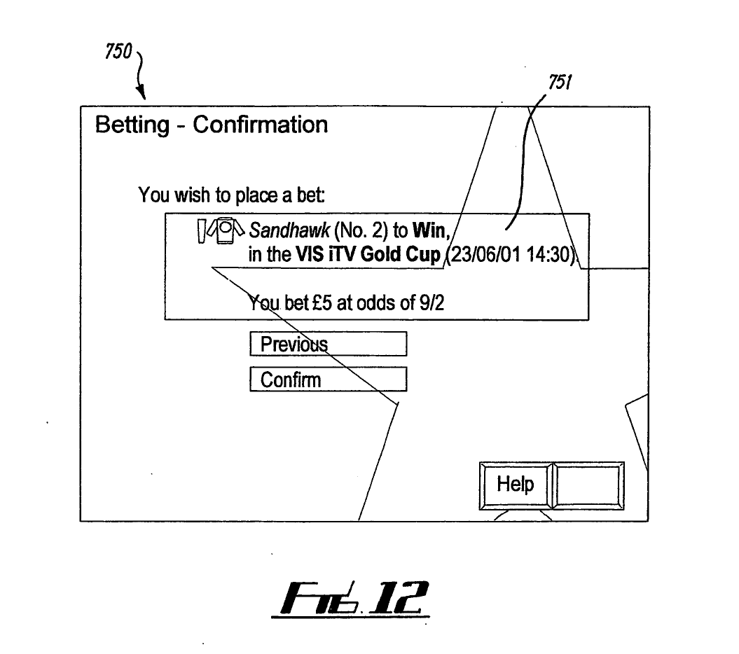

After selecting a particular race, the user is presented with bet placing screen 725 shown in FIG. 11. Selected horse details are then displayed 726 and a user is presented with a list of different types of bet 727, 728, 729. The user may indicate the type of bet desired. A user can use the remote control to input the numerical value of the amount of simulated or real money they wish to wager in box 730. A confirmation page 750 shown in FIG. 12 presents a summary of a bet 751 so that users can confirm using button 752 they wish the bet to be placed.

Bets can also be set up through other user interfaces such as the internet. The betting remains open during the call to action 631 illustrated in FIG. 6 before the race and betting closes at a set time (here two minutes) before the race. Preferably, the race is not actually determined by the race determination module 400 or rendered by the rendering module 200 until after betting has closed. This preserves secrecy and shortly thereafter the race is broadcast 628. Money, whether simulated or real, is paid out or taken in depending on the results of the race in a similar way to conventional bookmaking. Instructions to place a bet can be context sensitive, for example, during the parade 624 before the race pressing a single action button will initiate placing a bet on the particular horse in display, whereas at other times the user will have to select the horse from a menu.

Those skilled in the art will readily consider variations and alterations to the rules and format of the game, based on principles well-known in the field of computer games. It is also clear to those skilled in the art that the system can be used with other types of simulation based games. For example, other sporting games, such as football management game where players control teams and can buy, sell and train players entering them into league matches. Sports associated with betting are preferred, for example golf, soccer, baseball and motor racing. Other type of simulation can be envisaged, for example, a soap opera where the actions of the simulated characters are affected by instructions from individual players.

Simulations may be affected by votes cast by multiple players. The invention is also applicable to simulations of battles, melees and other competitions where many players compete. Other types of simulation games known in the art can be adapted for use with the technology herein disclosed.

The system therefore provides an enjoyable owner's game in which players may participate as race horse owners and trainers. Furthermore, it provides an interesting betting game and a method of raising revenue from the provision of commercial breaks 627, betting commissions or user participation fees.

The invention extends to computer programs in the form of source code, object code, code intermediate sources and object code (such as in a partially compiled form), or in any other form suitable for use in the implementation of the invention; for example, controlling the function of the game server 100, the rendering module 200, a set-top box 300 or the race simulating module 400. Computer programs may be standalone applications, software components or plug-ins to other applications. Computer programs embedding the invention may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for download across the internet from a server. Computer programs may also be embedded in an integrated circuit. Any and all such embodiments containing code that will cause a computer to perform substantially the invention principles as described, will fall within the scope of the invention. Similarly, certain functions disclosed herein may be carried out by specialised hardware, such as video generation and three dimensional graphics calculations. It is stipulated that all such variations are well within the ordinary skills of those skilled in the art and thus covered by this invention.

Further alterations and modifications may be made by one skilled in the art within the scope of the invention herein disclosed.

1. An entertainment system comprising:
a simulation module, adapted to run a simulation comprising calculative iterations and an outcome, the outcome being at least partially dependent on instructions received from a plurality of users;
input hardware for receiving instructions from users;
a rendering module for preparing signals corresponding to video images depicting aspects of the calculative iterations of the simulation, for feeding prior to said outcome being simulated said signals into a distribution network adapted for distributing said signals to a plurality of users.

2. The entertainment system of claim 1 wherein aspects of the simulation depend on random or pseudo-random numbers.

3. The entertainment system of claim 1 wherein a terminal is a set-top box.

4. The entertainment system of claim 1 wherein the simulation comprises a plurality of simulated entities having properties which affect the outcome of interactions therebetween, and wherein said video images depict interactions between said entities.

5. The entertainment system of claim 4 wherein said entities represent horses and further comprising a storage module adapted to store information about at least one of said horses said information comprising attributes affecting the horse performance in races; wherein user's instructions affect the development with time of horse's attributes; and, wherein the video images depict races between horses, the outcome of the races being at least partially responsive to the horse attributes.

6. The entertainment system of claim 1 further comprising television broadcast apparatus for broadcasting a television signal.

7. An entertainment server executing a simulation comprising calculative iterations and an outcome, and being adapted to receive instructions from a plurality of users; the users instructions affecting the simulation, the game server further being adapted to send to a rendering engine the information required for preparing a video image sequence relating to an aspect of the calculative iterations of the simulation; said video image sequence being for transmission through a distribution network prior to said outcome being simulated.

8. The entertainment server of claim 7 further adapted for storing information about entities, wherein entities have attributes affecting their performance in interactions, wherein users' instructions affect the development with time of entities' attributes and wherein the video images depict interactions between entities, the outcome of the interactions being responsive to the entities' attributes.

9. The entertainment server of claim 7 further adapted for storing information about horses, wherein horses have attributes affecting their performance in races, wherein users' instructions affect the development with time of horses' attributes and wherein the video images depict races between horses, the outcome of the races being responsive to the horses' attributes.

10. A method for interactive entertainment comprising the steps of:
receiving instructions from a plurality of users;
running a simulation comprising calculative iterations and an outcome, the development of the simulation at least partially dependent on the instructions received;
preparing signals corresponding to video images depicting aspects of the calculative iterations of the simulation; and
distributing said signals to a plurality of users prior to said outcome being simulated.

11. The method of claim 10 wherein said step of distributing is performed via a television distribution network.

12. The method of claim 10 wherein the development of the simulation further depends at least partially, on randomly or pseudo-randomly generated parameters.

13. The method of claim 10 wherein said instructions are received via user's set-top boxes.

14. The method of claim 10 wherein the simulation comprises simulated creatures having properties which affect the outcome of competitions and the video images depict competitions between creatures.

15. The method of claim 10 comprising the step of storing information about entities, wherein entities have attributes affecting their performance in interactions, wherein users' instructions affect the development with time of entities' attributes and wherein the video images depict interactions between entities, the outcome of the interactions being responsive to the entities' attributes.

16. The method of claim 10 comprising the step of storing information about horses, wherein horses have attributes affecting their performance in races, wherein users' instructions affect the development with time of horses' attributes and wherein the video images depict races between horses, the outcome of the races being responsive to the horses' attributes.

17. The method of claim 10 further comprising the step of preparing the video images for television broadcast.

18. A method of generating revenue comprising the steps of:
running a computer-based simulation comprising calculative iterations and an outcome, the outcome being at least partially dependent on instructions received from a plurality of users;
inviting players to place bets upon the outcome of depicted aspects of the simulation;
rendering video images depicting aspects of the calculative iterations of the simulation;
transmitting prior to said outcome being simulated said video images into a distribution network; and
paying out real or simulated money dependent on the outcome of depicted aspects of the simulation.

19. The method of claim 18 wherein the simulation simulates entities, wherein entities have attributes affecting their performance in interactions, wherein users' instructions affect the development with time of entities' attributes and wherein the video images depict interactions between entities, the outcome of the interactions being responsive to the entities' attributes.

20. The method of claim 18 wherein the simulation simulates horses, wherein horses have attributes affecting their performance in races, wherein user's instructions affect the development with time of horses' attributes and wherein the video images depict races between horses, the outcome of the races being responsive to the horses' attributes.

21. The method of claim 18 wherein the outcome of the depicted aspects of the simulation is dependent on random or pseudo-random numbers.

22. Computer software comprising program instructions which, when loaded onto a computer, cause said computer to perform as the entertainment server of claim 7.

23. Computer software comprising program instruction which, when loaded onto a computer, cause said computer to carry out the method of claim 10.

24. Computer software comprising program instruction which, when loaded onto a computer, cause said computer to carry out the method of claim 18.
